(19) United States
(12) Patent Application Publication
(10) Pub. No.: US 2023/0305328 A1
(43) Pub. Date: Sep. 28, 2023

(54) OPTICAL DEVICE AND OPTICAL RECEIVING DEVICE

(71) Applicant: Fujitsu Optical Components Limited, Kawasaki-shi (JP)

(72) Inventors: Akitoshi MESAKI, Kawasaki (JP); Tetsuo ISHIZAKA, Inagi (JP)

(73) Assignee: Fujitsu Optical Components Limited, Kawasaki-shi (JP)

(21) Appl. No.: 18/165,717

(22) Filed: Feb. 7, 2023

(30) Foreign Application Priority Data
Mar. 25, 2022 (JP) 2022-050955

(51) Int. Cl. G02F 1/09; H04B 10/61

(52) U.S. Cl. CPC G02F 1/093; H04B 10/615; G02F 2203/07; G02F 2203/70

(57) ABSTRACT

An optical device includes an optical amplifier that optically amplifies incident light, a first isolator that is arranged on an input stage of the optical amplifier and inputs the incident light to the optical amplifier, and a second isolator that is arranged on an output stage of the optical amplifier and receives input of incident light that has been optically amplified by the optical amplifier. The first isolator inputs, to the optical amplifier, first linearly-polarized incident light that is converted from randomly-polarized incident light and that has been transmitted. The second isolator, when reflected light of the first linearly-polarized incident light that has been optically amplified by the optical amplifier is input from a reverse direction, converts reflected light of the first linearly-polarized incident light to reflected light of second linearly-polarized light that is orthogonal to the reflected light of the first linearly-polarized incident light.

### CROSS-REFERENCE TO RELATED APPLICATION

This application is based upon and claims the benefit of priority of the prior Japanese Patent Application No. 2022-050955, filed on Mar. 25, 2022, the entire contents of which are incorporated herein by reference.

### FIELD

The embodiments discussed herein are related to an optical device and an optical receiving device.

### BACKGROUND

In recent years, along with the demand for an increase in a transmission distance, an optical receiver in which a semiconductor optical amplifier (SOA) that optically amplifies incident light coming from an optical fiber is incorporated is increasingly used. It is widely known that, in the optical receiver as described above, isolators are arranged on a front-stage and a rear-stage of the SOA along with the incorporation of the SOA.
Patent Literature 1: Japanese Laid-open Patent Publication No. 2000-221447
Patent Literature 2: U.S. Pat. No. 5,446,578, Specification
Patent Literature 3: U.S. Patent Application Publication No. 2003/0147136, Specification
Patent Literature 4: Japanese Laid-open Patent Publication No. 2004-264368
Patent Literature 5: Japanese Laid-open Patent Publication No. 2003-287713

However, in the conventional optical receiver as described above, each of the isolators that are arranged on the front stage and the rear stage of the SOA includes, for example, a plurality of birefringence crystals, a faraday rotator, a polarization unit, and the like, so that configurations of the isolators are complicated. As a result, it is difficult to reduce a size of the entire optical receiver in which the SOA is incorporated.

### SUMMARY

According to an aspect of an embodiment, an optical device includes an optical amplifier, a first isolator and a second isolator. The optical amplifier optically amplifies incident light. The first isolator is arranged on an input stage of the optical amplifier and inputs the incident light to the optical amplifier. The second isolator is arranged on an output stage of the optical amplifier and receives input of incident light that has been optically amplified by the optical amplifier. The first isolator converts randomly-polarized incident light into first linearly-polarized incident light, transmits the first linearly-polarized incident light, and inputs the transmitted first linearly-polarized incident light to the optical amplifier. The second isolator, when reflected light of the first linearly-polarized incident light that has been optically amplified by the optical amplifier is input from a reverse direction, converts the reflected light of the first linearly-polarized incident light into reflected light of second linearly-polarized light that is orthogonal to the reflected light of the first linearly-polarized incident light.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a configuration of an optical communication apparatus according to the present embodiment;

FIG. 2 is an explanatory diagram illustrating an example of a configuration of an optical receiver of a first embodiment;

FIG. 3 is an explanatory diagram illustrating an example of polarization states of incident light of a first isolator, incident light of a second isolator, ASE light of the first isolator, and reflected light of the second isolator in the optical receiver of the first embodiment;

FIG. 4 is an explanatory diagram illustrating an example of a configuration of an optical receiver of a second embodiment;

FIG. 5 is an explanatory diagram illustrating an example of polarization states of incident light of a first isolator, incident light of a third isolator, ASE light of the first isolator, and reflected light of the third isolator in the optical receiver of the second embodiment;

FIG. 6 is an explanatory diagram illustrating an example of a configuration of an optical receiver of a third embodiment;

FIG. 7 is an explanatory diagram illustrating an example of polarization states of incident light of a first isolator, incident light of a fourth isolator, ASE light of the first isolator, and incident light of the fourth isolator in the optical receiver of the third embodiment;

FIG. 8 is an explanatory diagram illustrating an example of a configuration of an optical receiver of a comparative example; and

FIG. 9 is an explanatory diagram illustrating an example of polarization states of incident light of a front-stage isolator, ASE light of the front-stage isolator, and reflected light of a rear-stage isolator of the optical receiver of the comparative example.

### DESCRIPTION OF EMBODIMENTS

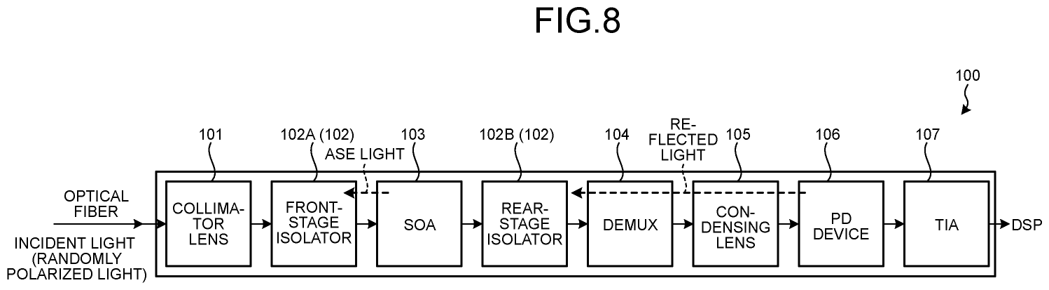

FIG. 8 is an explanatory diagram illustrating an example of a configuration of an optical receiver 100 of a comparative example. The optical receiver 100 illustrated in FIG. 8 includes a collimator lens 101, a front-stage isolator 102A (102), a semiconductor optical amplifier (SOA) 103, and a rear-stage isolator 102B (102). Further, the optical receiver 100 includes a demultiplexer (DEMUX) 104, a condensing lens 105, a photodiode (PD) device 106, and a transimpedance amplifier (TIA) 107. The collimator lens 101 is a lens that converts randomly-polarized incident light coming from an optical fiber into parallel incident light. Meanwhile, the incident light is wavelength multiplexed light, for example. If the incident light is single wave, the DEMUX 104 is not needed.

The front-stage isolator 102A is arranged between the collimator lens 101 and the SOA 103. The front-stage isolator 102A converts, as a function in a forward direction from the collimator lens 101 to the SOA 103, the parallel incident light that is input from the collimator lens 101 into linearly-polarized incident light that is in an orthogonal state, and emits the converted linearly-polarized incident that is in the orthogonal state to the SOA 103. Furthermore, the front-stage isolator 102A blocks, as a function in a reverse direction from the SOA 103 to the collimator lens 101, incidence of amplified spontaneous emission (ASE) light that travels from the SOA 103 to the optical fiber. Meanwhile, the ASE light is spontaneous emission light that is generated in accordance with optical amplification performed by the SOA 103.

The SOA 103 is a semiconductor optical amplifier that optically amplifies the linearly-polarized incident that is in the orthogonal state and that comes from the front-stage isolator 102A. The rear-stage isolator 102B is arranged between the SOA 103 and the DEMUX 104, and emits, as a function in the forward direction from the SOA 103 to the DEMUX 104, the linearly-polarized incident light that is in the orthogonal state and that is optically amplified by the SOA 103 to the DEMUX 104. Moreover, the rear-stage isolator 102B blocks, as a function in the reverse direction from the DEMUX 104 to the SOA 103, incidence of reflected light from the PD device 106 to the SOA 103. Meanwhile, the reflected light is light that is obtained when the linearly-polarized incident light that is in the orthogonal state is reflected on a light receiving surface of the PD device 106.

The DEMUX 104 splits the wavelength multiplexed light, which is the linearly-polarized incident light that is in the orthogonal state and that is input from the rear-stage isolator 102B, in units of wavelengths, and inputs each beam of the split wavelength light to each of the condensing lenses 105 corresponding to each wavelength light. The condensing lens 105, the PD device 106, and the TIA 107 are provided for each wavelength unit.

Each of the condensing lenses 105 condenses light such that the wavelength light split by the DEMUX 104 is input to the PD device 106 corresponding to the wavelength light. Each of the PD devices 106 performs current conversion on the wavelength light coming from the condensing lens 105, and outputs a current signal subjected to the current conversion to the TIA 107 corresponding to the wavelength light. Each of the TIAs 107 converts the current signal coming from the PD device 106 to a voltage signal, and outputs the converted voltage signal to a digital signal processor (DSP).

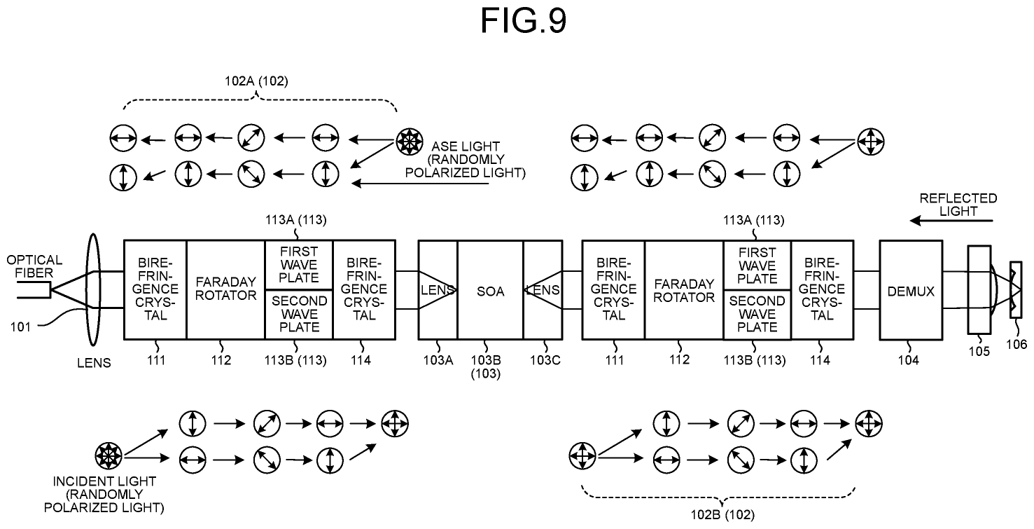

FIG. 9 is an explanatory diagram illustrating an example of polarization states of incident light of the front-stage isolator 102A, incident light of the rear-stage isolator 102B, ASE light of the front-stage isolator 102A, and reflected light of the rear-stage isolator 102B in the optical receiver 100 of the comparative example.

The front-stage isolator 102A includes a front-stage birefringence crystal 111, a faraday rotator 112, a polarization unit 113, and a rear-stage birefringence crystal 114. The front-stage birefringence crystal 111 is an optical component that, upon incidence of parallel incident light from the collimator lens 101, refracts and splits the parallel incident light into a vertically polarized component and a horizontally polarized component that are linearly-polarized light in orthogonal states that are orthogonal to each other. The vertically polarized component is a polarized component for which an optical path extends in a vertical direction, and the horizontally polarized component is a polarized component for which an optical path extends in a horizontal direction. The faraday rotator 112 is a non-reciprocal optical component that, upon incidence of the linearly-polarized light that travels in a certain direction that matches a direction of a magnetic field, rotates a polarization direction of the linearly-polarized light by 45 degrees in a clockwise direction. The faraday rotator 112 rotates the polarization directions of the vertically polarized component and the horizontally polarized component, which are split by the front-stage birefringence crystal 111, by 45 degrees in the clockwise direction.

The polarization unit 113 is an optical component that includes a first wave plate 113A and a second wave plate 113B each of which rotates the polarization direction of the linearly-polarized incident light by 45 degrees in the clockwise direction. The first wave plate 113A further rotates the polarization direction of the vertically polarized component, which has been rotated by 45 degrees by the faraday rotator 112, by 45 degrees in the clockwise direction to obtain linearly-polarized light of a horizontally polarized component. The second wave plate 113B further rotates the polarization direction of the horizontally polarized component, which has been rotated by 45 degrees by the faraday rotator 112, by 45 degrees in the clockwise direction to obtain linearly-polarized light of a vertically polarized component. The rear-stage birefringence crystal 114 refracts and multiplexes the linearly-polarized light of the horizontally polarized component coming from the first wave plate 113A and the linearly-polarized light of the vertically polarized component coming from the second wave plate 113B to obtain linearly-polarized light in the orthogonal state.

The SOA 103 includes a front-stage lens 103A, an SOA main body 103B, and a rear-stage lens 103C. The front-stage lens 103A is a lens that collects the linearly-polarized incident light that is in the orthogonal state and that comes from the rear-stage birefringence crystal 114 in the front-stage isolator 102A to an optical amplification area in the SOA main body 103B. The SOA main body 103B optically amplifies the linearly-polarized incident light that is in the orthogonal state and that is collected by the front-stage lens 103A. The rear-stage lens 103C is a lens that converts the linearly-polarized incident light that is in the orthogonal state and that is optically amplified by the SOA main body 103B into parallel light.

First, a polarization state of incident light that travels in the forward direction from the collimator lens 101 to the SOA 103 in the front-stage isolator 102A will be described. The front-stage birefringence crystal 111 in the front-stage isolator 102A, upon incidence of the parallel incident light from the collimator lens 101, splits the parallel incident light into a vertically polarized component and a horizontally polarized component that are linearly-polarized light that are orthogonal to each other. The faraday rotator 112 rotates polarization directions of the vertically polarized component and the horizontally polarized component, which are split by the front-stage birefringence crystal 111, by 45 degrees in the clockwise direction.

The first wave plate 113A in the polarization unit 113 rotates the vertically polarized component, which has been rotated by 45 degrees in the clockwise direction by the faraday rotator 112, by 45 degrees in the clockwise direction 45 to obtain linearly-polarized light of a horizontally polarized component. The second wave plate 113B in the polarization unit 113 rotates the horizontally polarized component, which has been rotated by 45 degrees in the clockwise direction by the faraday rotator 112, by 45 degrees in the clockwise direction to obtain linearly-polarized light of a vertically polarized component. The rear-stage birefringence crystal 114 refracts and multiplexes the linearly-polarized light of the horizontally polarized component coming from the first wave plate 113A and the linearly-polarized light of the vertically polarized component coming from the second wave plate 113B, and inputs linearly-polarized incident light that is in the orthogonal state to the front-stage lens 103A in the SOA 103.

A polarization state of ASE light that is emitted in the reverse direction from the SOA 103 to the collimator lens 101 in the front-stage isolator 102A will be described below. The SOA 103 emits randomly-polarized ASE light that is generated from the SOA main body 103B to the front-stage lens 103A in the reverse direction. The front-stage lens 103A in the SOA 103 converts the randomly-polarized ASE light coming from the SOA main body 103B into parallel light.

The rear-stage birefringence crystal 114 in the front-stage isolator 102A, upon incidence of the ASE light that is the parallel light from the front-stage lens 103A, refracts and splits the ASE light that is the parallel light into a horizontally polarized component and a vertically polarized component that are orthogonal to each other. The first wave plate 113A in the polarization unit 113 rotates the horizontally polarized component, which has been split by the rear-stage birefringence crystal 114, by 45 degrees in a counterclockwise direction. The second wave plate 113B in the polarization unit 113 rotates the vertically polarized component, which has been split by the rear-stage birefringence crystal 114, by 45 degrees in the counterclockwise direction.

The faraday rotator 112 has a non-reciprocal property such that the polarization directions of the linearly-polarized light in the forward direction and in the reverse direction are rotated in the same direction. Therefore, the faraday rotator 112 rotates the horizontally polarized component, which comes from the first wave plate 113A after being rotated by 45 degrees in the counterclockwise direction, and the vertically polarized component, which comes from the second wave plate 113B after being rotated by 45 degrees in the counterclockwise direction, by 45 degrees in the clockwise direction. In other words, the faraday rotator 112 rotates the horizontally polarized component, which comes from the first wave plate 113A after being rotated by 45 degrees in the counterclockwise direction, by 45 degrees in the clockwise direction to obtain a horizontally polarized component. Furthermore, the faraday rotator 112 rotates the vertically polarized component, which comes from the second wave plate 113B after being rotated by 45 degrees in the counterclockwise direction, by 45 degrees in the clockwise direction to obtain a vertically polarized component.

Moreover, even if the horizontally polarized component and the vertically polarized component are input from the faraday rotator 112, the front-stage birefringence crystal 111 refracts the horizontally polarized component and the vertically polarized component in directions in which the components do not optically coupled with each other. In other words, the front-stage birefringence crystal 111 in the front-stage isolator 102A emits light at a position that is deviated from a position of incident light. As a result, in the front-stage isolator 102A, the front-stage birefringence crystal 111 blocks incidence of the ASE light coming from the reverse direction to the optical fiber via the collimator lens 101.

The rear-stage isolator 102B includes the front-stage birefringence crystal 111, the faraday rotator 112, the polarization unit 113, and the rear-stage birefringence crystal 114. Meanwhile, the rear-stage isolator 102B has the same internal configuration as the configuration of the front-stage isolator 102A.

A polarization state of incident light that travels in the forward direction from the SOA 103 of the rear-stage isolator 102B to the DEMUX 104 will be described below. The front-stage birefringence crystal 111 in the rear-stage isolator 102B, when the linearly-polarized incident light that is optically amplified is input in the forward direction from the SOA 103, refracts and splits the linearly-polarized incident light that is in the orthogonal state into a vertically polarized component and a horizontally polarized component. The faraday rotator 112 rotates the vertically polarized component and the horizontally polarized component, which have been split by the front-stage birefringence crystal 111, by 45 degrees in the clockwise direction

The first wave plate 113A in the polarization unit 113 rotates the vertically polarized component, which has been rotated by 45 degrees in the clockwise direction by the faraday rotator 112, by 45 degrees in the clockwise direction to obtain linearly-polarized light of a horizontally polarized component. The second wave plate 113B in the polarization unit 113 rotates the horizontally polarized component, which has been rotated by 45 degrees in the clockwise direction by the faraday rotator 112, by 45 degrees in the clockwise direction to obtain a linearly-polarized light of a vertically polarized component. Furthermore, the rear-stage birefringence crystal 114 refracts and multiplexes the horizontally polarized component coming from the first wave plate 113A and the vertically polarized component coming from the second wave plate 113B. Moreover, the rear-stage birefringence crystal 114 inputs the multiplexed incident light that is linearly-polarized light in the orthogonal state to the DEMUX 104.

A polarization state of reflected light that travels in the reverse direction from the PD device 106 to the SOA 103 in the rear-stage isolator 102B will be described below. The rear-stage birefringence crystal 114 in the rear-stage isolator 102B, when reflected light of the linearly-polarized light in the orthogonal state is input in the reverse direction from the PD device 106 via the DEMUX 104, refracts and splits the reflected light into a horizontally polarized component and a vertically polarized component. The first wave plate 113A in the polarization unit 113 rotates the horizontally polarized component, which has been split by the rear-stage birefringence crystal 114, by 45 degrees in the counterclockwise direction. The second wave plate 113B in the polarization unit 113 rotates the vertically polarized component, which has been split by the rear-stage birefringence crystal 114, by 45 degrees in the counterclockwise direction.

The faraday rotator 112 has a non-reciprocal property such that the polarization directions of the linearly-polarized light in the forward direction and in the reverse direction are rotated in the same direction. The faraday rotator 112 rotates the horizontally polarized component, which comes from the first wave plate 113A after being rotated by 45 degrees in the counterclockwise direction, and the vertically polarized component, which comes from the second wave plate 113B after being rotated by 45 degrees in the counterclockwise direction, by 45 degrees in the clockwise direction. In other words, the faraday rotator 112 rotates the horizontally polarized component, which comes from the first wave plate 113A after being rotated by 45 degrees in the counterclockwise direction, by 45 degrees in the clockwise direction to obtain a horizontally polarized component. The faraday rotator 112 rotates the vertically polarized component, which comes from the second wave plate 113B after being rotated by 45 degrees in the counterclockwise direction, by 45 degrees in the clockwise direction to obtain a vertically polarized component.

Furthermore, even if the horizontally polarized component and the vertically polarized component are input from the faraday rotator 112, the front-stage birefringence crystal 111 refracts the horizontally polarized component and the vertically polarized component in directions in which the components do not optically coupled with each other. In other words, the front-stage birefringence crystal 111 in the rear-stage isolator 102B emits light at a position that is deviated from a position of incident light. As a result, in the rear-stage isolator 102B, the front-stage birefringence crystal 111 blocks incidence of the reflected light coming from the reverse direction to the SOA 103 via the lens 103C.

However, in the optical receiver 100 of the comparative example, the internal configurations of the front-stage isolator 102A and the rear-stage isolator 102B are complicated, so that it is difficult to reduce the size of the entire optical receiver 100. Therefore, embodiments of an optical device or the like, such as an optical receiver, that copes with the situations as described above will be described in detail below with reference to the drawings. The present invention is not limited by the embodiments below.

### (a) First Embodiment

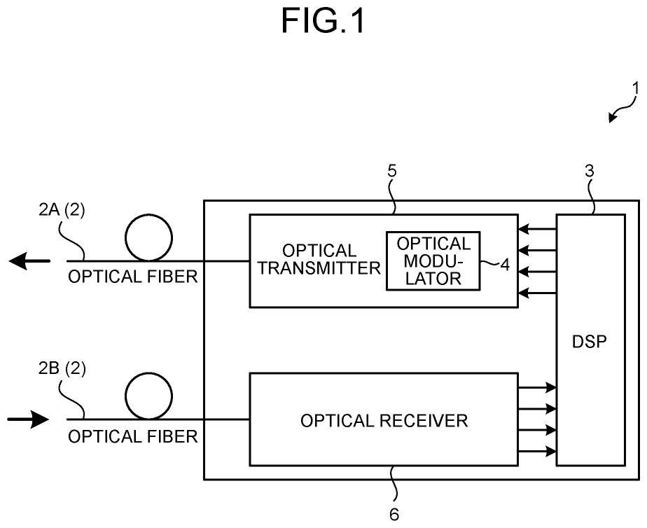

FIG. 1 is an explanatory diagram illustrating an example of a configuration of an optical communication apparatus 1 according to the present embodiment. The optical communication apparatus 1 illustrated in FIG. 1 is connected to an optical fiber 2A (2) at an output side and an optical fiber 2B (2) at an input side. The optical communication apparatus 1 is a digital transceiver that includes a digital signal processor (DSP) 3, an optical transmitter 5 in which an optical modulator 4 is incorporated, and an optical receiver 6. The DSP 3 is an electrical component that performs digital signal processing. For example, the DSP 3 performs processing, such as encoding, on transmission data, generates an electrical signal including the transmission data, and transmits the generated electrical signal (voltage signal) to the optical transmitter 5. Further, the DSP 3 acquires an electrical signal (voltage signal) including reception data from the optical receiver 6, performs processing, such as decoding, on the acquired electrical signal, and obtains the reception data. The optical modulator 4 may be arranged outside the optical transmitter 5.

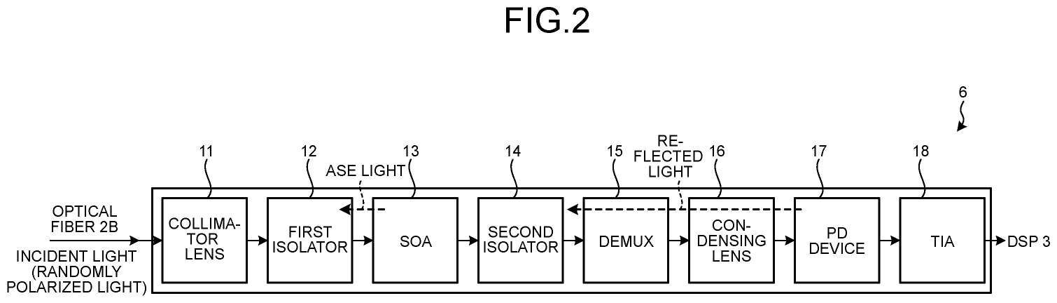

FIG. 2 is an explanatory diagram illustrating an example of a configuration of the optical receiver 6 of the first embodiment. The optical receiver 6 illustrated in FIG. 2 includes a collimator lens 11, a first isolator 12, a semiconductor optical amplifier (SOA) 13, a second isolator 14, and a demultiplexer (DEMUX) 15. Furthermore, the optical receiver 6 includes a condensing lens 16, a photodiode (PD) device 17, and a transimpedance amplifier (TIA) 18. The collimator lens 11 is a lens that converts randomly-polarized incident light coming from the optical fiber 2B into parallel incident light. Meanwhile, the incident light is wavelength multiplexed light, for example.

The first isolator 12 is arranged between the collimator lens 11 and the SOA 13. The first isolator 12 converts, as a function in a forward direction from the collimator lens 11 to the SOA 13, the parallel incident light that comes from the collimator lens 11 into linearly-polarized incident light, and outputs the converted linearly-polarized incident light to the SOA 13. The first isolator 12 blocks, as a function in a reverse direction from the SOA 13 to the collimator lens 11, incidence of amplified spontaneous emission (ASE) light from the SOA 13 to the optical fiber 2B. Meanwhile, the ASE light is spontaneous emission light that is generated in accordance with optical amplification performed by the SOA 13.

The SOA 13 is a semiconductor optical amplifier that optically amplifies the linearly-polarized incident light that comes from the first isolator 12. The second isolator 14 is arranged between the SOA 13 and the DEMUX 15, and emits, as a function in the forward direction from the SOA 13 to the DEMUX 15, the linearly-polarized incident light that is optically amplified by the SOA 13 to the DEMUX 15. The second isolator 14 blocks, as a function in the reverse direction from the DEMUX 15 to the SOA 13, incidence of reflected light from the PD device 17 to the SOA 13. Meanwhile, the reflected light is light that is obtained when the linearly-polarized incident light is reflected on a light receiving surface of the PD device 17.

The DEMUX 15 splits the wavelength multiplexed light, which is the linearly-polarized incident light input from the second isolator 14, in units of wavelengths, and inputs each beam of the split wavelength light to each of the condensing lenses 16 corresponding to each wavelength light. The condensing lens 16, the PD device 17, and the TIA 18 are provided for each wavelength unit.

Each of the condensing lenses 16 condenses light such that the wavelength light split by the DEMUX 15 is input to the PD device 17 corresponding to the wavelength light. Each of the PD devices 17 performs current conversion on the wavelength light coming from the condensing lens 16, and outputs a current signal subjected to the current conversion to the TIA 18 corresponding to the wavelength light. Each of the TIAs 18 converts the current signal coming from the PD device 17 to a voltage signal, and outputs the converted voltage signal to the DSP 3.

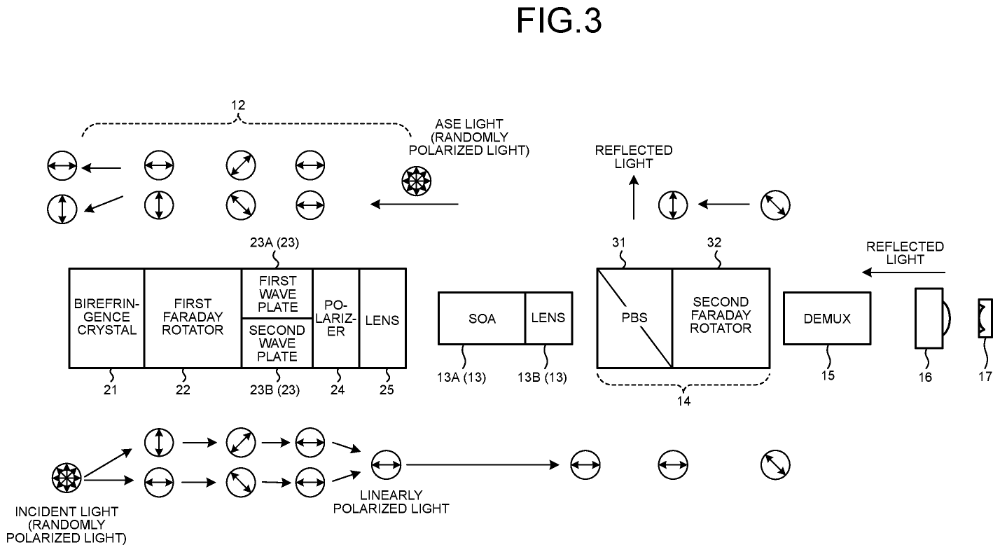

FIG. 3 is an explanatory diagram illustrating an example of polarization states of incident light of the first isolator 12, incident light of the second isolator 14, ASE light of the first isolator 12, and reflected light of the second isolator 14 in the optical receiver 6 of the first embodiment.

The first isolator 12 includes a birefringence crystal 21, a first faraday rotator 22, a polarization unit 23, a polarizer 24, and a lens 25. The birefringence crystal 21 is an optical component that, upon incidence of parallel incident light from the collimator lens 11, refracts and splits the parallel incident light into a vertically polarized component and a horizontally polarized component that are linearly-polarized light that are orthogonal to each other. Meanwhile, for convenience of explanation, the vertically polarized component may be referred to as, for example, second linearly-polarized light, and the horizontally polarized component may be referred to as, for example, first linearly-polarized light. The vertically polarized component is a polarized component for which an optical path extends in the vertical direction, and the horizontally polarized component is a polarized component for which an optical path extends in a horizontal direction.

The first faraday rotator 22 is a non-reciprocal optical component that, upon incidence of the linearly-polarized light that travels in a certain direction that matches a direction of a magnetic field, rotates a polarization direction of the linearly-polarized light by 45 degrees in the clockwise direction. The first faraday rotator 22 rotates the polarization directions of the vertically polarized component and the horizontally polarized component, which are split by the birefringence crystal 21, by 45 degrees in the clockwise direction.

The polarization unit 23 is an optical component that includes a first wave plate 23A that rotates the polarization direction of the linearly-polarized incident light by 45 degrees in the clockwise direction, and a second wave plate 23B that rotates the polarization direction of the linearly-polarized incident light by 45 degrees in the counterclockwise direction. The first wave plate 23A rotates the polarization direction of the vertically polarized component, which has been rotated by 45 degrees in the clockwise direction by the first faraday rotator 22, by 45 degrees in the clockwise direction to obtain linearly-polarized light of a horizontally polarized component. The second wave plate 23B rotates the polarization direction of the horizontally polarized component, which has been rotated by 45 degrees in the clockwise direction by the first faraday rotator 22, by 45 degrees in the counterclockwise direction to obtain linearly-polarized light of a horizontally polarized component.

The polarizer 24 is an optical component that transmits only the horizontally polarized component from the linearly-polarized light of the horizontally polarized component coming from the first wave plate 23A and the horizontally polarized component coming from the second wave plate 23B. The lens 25 is an optical component that collects the linearly-polarized light of the horizontally polarized component that has transmitted through the polarizer 24.

The SOA 13 includes an SOA main body 13A and a rear-stage lens 13B. The SOA main body 13A optically amplifies incident light of the linearly-polarized light of the horizontally polarized component that is collected by the lens 25 in the first isolator 12. Meanwhile, the lens 25 inputs the collected incident light of the linearly-polarized light of the horizontally polarized component to an optical amplification area of the SOA main body 13A in the SOA 13. The rear-stage lens 13B is a lens that converts the incident light that is optically amplified by the SOA main body 13A into parallel light.

First, a polarization state of the incident light that travels in the forward direction from the collimator lens 11 to the SOA 13 in the first isolator 12 will be described. The birefringence crystal 21 in the first isolator 12, upon incidence of the parallel incident light from the collimator lens 11, refracts and splits the parallel incident light into a vertically polarized component and a horizontally polarized component that are linearly-polarized light that are orthogonal to each other. The first faraday rotator 22 rotates the polarization directions of the vertically polarized component and the horizontally polarized component, which are split by the birefringence crystal 21, by 45 degrees in the clockwise direction.

The first wave plate 23A in the polarization unit 23 rotates the vertically polarized component, which has been rotated by 45 degrees in the clockwise direction by the first faraday rotator 22, by 45 degrees in the clockwise direction to obtain linearly-polarized light of a horizontally polarized component. The second wave plate 23B in the polarization unit 23 rotates the horizontally polarized component, which has been rotated by 45 degrees in the clockwise direction by the first faraday rotator 22, by 45 degrees in the counterclockwise direction to obtain linearly-polarized light of a horizontally polarized component. Further, the polarizer 24 transmits only the linearly-polarized light of the horizontally polarized component from the horizontally polarized component coming from the first wave plate 23A and the horizontally polarized component from the second wave plate 23B. The lens 25 collects the linearly-polarized light of the horizontally polarized component that has transmitted through the polarizer 24. Furthermore, the lens 25 inputs the collected incident light of the linearly-polarized light of the horizontally polarized component to the optical amplification area of the SOA 13.

A polarization state of the ASE light that travels in the reverse direction from the SOA 13 to the collimator lens 11 in the first isolator 12 will be described below. The SOA 103 inputs randomly polarized ASE light, which is generated from the SOA main body 103B, to the lens 25 in the first isolator 12 in the reverse direction. The lens 25 in the first isolator 12, upon incidence of the randomly polarized ASE light from the SOA 13 in the reverse direction, converts the randomly polarized ASE light into parallel ASE light. The polarizer 24, upon incidence of the parallel ASE light from the lens 25, transmits only the linearly-polarized light of the horizontally polarized component from the parallel ASE light.

The first wave plate 23A in the polarization unit 23 rotates the horizontally polarized component, which has transmitted through the polarizer 24, by 45 degrees in the counterclockwise direction. The second wave plate 23B in the polarization unit 23 rotates the horizontally polarized component, which has transmitted through the polarizer 24, by 45 degrees in the clockwise direction. The first faraday rotator 22 has a non-reciprocal property so as to perform rotation in the same direction both in the forward direction and the reverse direction. The first faraday rotator 22 rotates the horizontally polarized component, which comes from the first wave plate 23A after being rotated by 45 degrees in the counterclockwise direction, by 45 degrees in the clockwise direction to obtain linearly-polarized ASE light of a horizontally polarized component. The first faraday rotator 22 rotates the horizontally polarized component, which comes from the second wave plate 23B after being rotated by 45 degrees in the clockwise direction, by 45 degrees in the clockwise direction to obtain linearly-polarized ASE light of a vertically polarized component.

Furthermore, even if the linearly-polarized ASE light of the horizontally polarized component and the vertically polarized component are input from the first faraday rotator 22 in the reverse direction, the birefringence crystal 21 refracts the linearly-polarized light of the horizontally polarized component and the linearly-polarized light of the vertically polarized component in directions in which the linearly-polarized light do not optically coupled with each other. The birefringence crystal 21 transmits the horizontally polarized component coming from the first faraday rotator 22 without refracting the horizontally polarized component, and transmits the vertically polarized component coming from the first faraday rotator 22 after refracting the vertically polarized component. In other words, the birefringence crystal 21 emits light at a position that is deviated from a position of incident light. As a result, the first isolator 12 blocks, by the birefringence crystal 21, incidence of the ASE light to the optical fiber via the collimator lens 11 in the reverse direction.

The second isolator 14 includes a polarization beam splitter (PBS) 31 and a second faraday rotator 32. The PBS 31 is an optical component that transmits only the linearly-polarized incident light of the horizontally polarized component that has been optically amplified and comes from the SOA 13, and splits the incident light other than the horizontally polarized component. The second faraday rotator 32 is an optical component that rotates the linearly-polarized incident light of the horizontally polarized component, which has transmitted through the PBS 31, by 45 degrees in the clockwise direction.

A polarization state of incident light that travels in the forward direction from the SOA 13 to the DEMUX 15 in the second isolator 14 will be described. The PBS 31 in the second isolator 14, when the incident light of the linearly-polarized light of the horizontally polarized component that has been optically amplified is input in the forward direction from the SOA 13, transmits only the incident light of the horizontally polarized component. The second faraday rotator 32 rotates the horizontally polarized component of the linearly-polarized light, which has transmitted through the PBS 31, by 45 degrees in the clockwise direction. Further, the second faraday rotator 32 inputs the incident light of the linearly-polarized light of the horizontally polarized component, which has been rotated by 45 degrees in the clockwise direction, to the DEMUX 15.

A polarization state of reflected light that travels in the reverse direction from the PD device 17 to the SOA 13 in the second isolator 14 will be described below. The second faraday rotator 32 in the second isolator 14 receives input of reflected light of the incident light of the linearly-polarized light of the horizontally polarized component that has been rotated by 45 degrees in the clockwise direction, from the light receiving surface of the PD device 17 via the DEMUX 15 in the reverse direction. The second faraday rotator 32 has a non-reciprocal property so as to perform rotate in the same direction both in the forward direction and the reverse direction. The second faraday rotator 32, when the reflected light of the horizontally polarized component that has been rotated by 45 degrees in the clockwise direction is input from the reverse direction, rotates the reflected light of the horizontally polarized component, which has been rotated by 45 degrees in the clockwise direction, by 45 degrees in the clockwise direction to obtain reflected light of a vertically polarized component of linearly-polarized light.

The PBS 31 transmits only a horizontally polarized component even in the reverse direction, and therefore blocks the reflected light of the vertically polarized component coming from the second faraday rotator 32. As a result, in the second isolator 14, because the reflected light from the reverse direction of the second faraday rotator 32 is the vertically polarized component with the polarization direction that is orthogonal to the incident light, the PBS 31 is able to block the reflected light toward the SOA 13.

The first isolator 12 in the optical receiver 6 of the first embodiment transmits the incident light of the horizontally polarized component from randomly-polarized incident light, and inputs the transmitted incident light of the horizontally polarized component to the SOA 13. Furthermore, the second isolator 14, when the reflected light of the incident light of the horizontally polarized component that has been optically amplified by the SOA 13 is input from the reverse direction, converts the reflected light of the horizontally polarized component into reflected light of a vertically polarized component that is an orthogonal component. As a result, when the reflected light of the incident light of the horizontally polarized component that has been optically amplified is input from the reverse direction, the second isolator 14 converts the reflected light of the horizontally polarized component into the reflected light of the vertically polarized component that is an orthogonal component. Furthermore, the reflected light in the reverse direction toward the SOA 13 is orthogonal to the incident light, so that it is possible to block incidence of the reflected light.

The first isolator 12 includes the first wave plate 23A that rotates the vertically polarized component, which comes from the first faraday rotator 22 after being rotated by 45 degrees in the clockwise direction, by 45 degrees in the clockwise direction to obtain a horizontally polarized component. Furthermore, the first isolator 12 includes the second wave plate 23B that rotates the horizontally polarized component, which comes from the first faraday rotator 22 after being rotated by 45 degrees in the clockwise direction, by 45 degrees in the counterclockwise direction to obtain a horizontally polarized component. Moreover, the polarizer 24 transmits only the incident light of the horizontally polarized component from the horizontally polarized component coming from the first wave plate 23A and the horizontally polarized component coming from the second wave plate 23B. The lens 25 collects the horizontally polarized component coming from the first wave plate 23A and the horizontally polarized component coming from the second wave plate 23B such that the components are input to the SOA 13. As a result, the first isolator 12 inputs the polarized component of the horizontally polarized component that is the single linearly-polarized light to the SOA 13, so that a conventional condensing lens on the front stage of the SOA 13 is not needed.

The polarizer 24, upon incidence of the parallel ASE light from the lens 25, transmits only the horizontally polarized component of the incident parallel ASE light, and the first wave plate 23A rotates the horizontally polarized component of the light, which has been transmitted through the polarizer 24 and input to the first wave plate 23A, by 45 degrees in the counterclockwise direction. The second wave plate 23B rotates the horizontally polarized component of the light, which has been transmitted through the polarizer 24 and input to the second wave plate 23B, by 45 degrees in the clockwise direction. The first faraday rotator 22 rotates the horizontally polarized component, which comes from the first wave plate 23A after being rotated by 45 degrees in the counterclockwise direction, by 45 degrees in the clockwise direction to obtain a horizontally polarized component that is totally rotated by 0 degree. The first faraday rotator 22 rotates the horizontally polarized component, which comes the second wave plate 23B after being rotated by 45 degrees in the clockwise direction, by 45 degrees in the clockwise direction to obtain a vertically polarized component that is a horizontally polarized component that is totally rotated by 90 degrees. The birefringence crystal 21 refracts the horizontally polarized component and the vertically polarized component coming from the first faraday rotator 22, in directions in which the components do not optically coupled with each other r, and blocks incidence of the ASE light to the optical fiber via the collimator lens 11. As a result, in the first isolator 12, the polarizer 24 blocks only the horizontally polarized component of the linearly-polarized light from the ASE light, and the polarization unit 23 performs polarization rotation, so that a polarized component that is opposite to the incident light is obtained by the first faraday rotator 22. Furthermore, it is possible to block incidence of the ASE light from the SOA 13 to the optical fiber via the collimator lens 11.

The second isolator 14 includes the PBS 31 that, upon incidence of the incident light of the horizontally polarized component that is optically amplified, transmits the horizontally polarized component from the incident light of the horizontally polarized component, and the second faraday rotator 32 that rotates the horizontally polarized component, which has transmitted through the PBS 31, by 45 degrees in the clockwise direction. The second faraday rotator 32, when the reflected light of the incident light of the horizontally polarized component that has been rotated by 45 degrees is input from the reverse direction, rotates the reflected light by 45 degrees in the clockwise direction, so as to obtain reflected light of a vertically polarized component from the reflected light of the horizontally polarized component that has been rotated by 45 degrees in the clockwise direction. Furthermore, the PBS 31 blocks incidence of the reflected light of the vertically polarized component from the second faraday rotator 32 to the SOA 13. As a result, the internal configuration of the second isolator 14 is simplified, so that it is possible to reduce the size of the entire optical receiver 6.

The second isolator 14 inputs the single linearly-polarized incident light to the PD device 17, so that reflected light that is reflected on the light receiving surface of the PD device 17 is also the single linearly-polarized light; therefore, the birefringence crystal and the polarization unit as in the comparative example are not needed.

Meanwhile, the example has been described in which the polarizer 24 in the first isolator 12 transmits only the horizontally polarized component, but the polarizer 24 may be replaced with the PBS 31 that transmits only the horizontally polarized component, and an appropriate change is applicable.

Furthermore, the example has been described in which the first faraday rotator 22 in the first isolator 12 rotates the linearly-polarized light by 45 degrees in the clockwise direction, but it may be possible to rotate the linearly-polarized light by 45 degrees in the counterclockwise direction, and an appropriate change is applicable.

Moreover, the example has been described in which the first wave plate 23A in the polarization unit 23 in the first isolator 12 rotates the vertically polarized component, which has been rotated by 45 degrees in the clockwise direction by the first faraday rotator 22, by 45 degrees in the clockwise direction to obtain a horizontally polarized component. Furthermore, the example has been described in which the second wave plate 23B rotates the horizontally polarized component, which has been rotated by 45 degrees in the clockwise direction by the first faraday rotator 22, by 45 degrees in the counterclockwise direction to obtain a horizontally polarized component. However, the first wave plate 23A may rotates the vertically polarized component, which has been rotated by 45 degrees in the clockwise direction the first faraday rotator 22, by 45 degrees in the counterclockwise direction to obtain a vertically polarized component. Furthermore, the second wave plate 23B may rotate the horizontally polarized component, which has been rotated by 45 degrees in the clockwise direction by the first faraday rotator 22, by 45 degrees in the clockwise direction to obtain a vertically polarized component. In this case, the polarizer 24 and the PBS 31 in the second isolator 14 transmit only incident light of the linearly-polarized light of the vertically polarized component, and the second faraday rotator 32 inputs e reflected light of the horizontally polarized component to the PBS 31. Moreover, it may be possible to block incidence of the reflected light of the horizontally polarized component to the SOA 13, and an appropriate change is applicable.

The example has been described in which, in the optical receiver 6 of the first embodiment, the lens 25 that collects the horizontally polarized component of the linearly-polarized light that transmits through the polarizer 24 is arranged inside the first isolator 12, but the lens 25 need not always be arranged inside the first isolator 12, and an appropriate change is applicable.

The example has been described in which the optical receiver 6 blocks, by the second isolator 14, incidence of the reflected light, which is reflected on the light receiving surface of the PD device 17, to the SOA 13. However, the reflected light is not limited to the reflected light from the light receiving surface of the PD device 17, and the same effect is achieved even with reflected light from the DEMUX 15, the condensing lens 16, or the like. The PD device 17 may be, for example, a planar PD or a lens PD, and an appropriate change is applicable.

Meanwhile, the example has been described in which the second isolator 14 of the optical receiver 6 of the first embodiment includes the PBS 31 and the second faraday rotator 32, but embodiments are not limited to this example, and a different embodiment will be described below as a second embodiment.

### (b) Second Embodiment

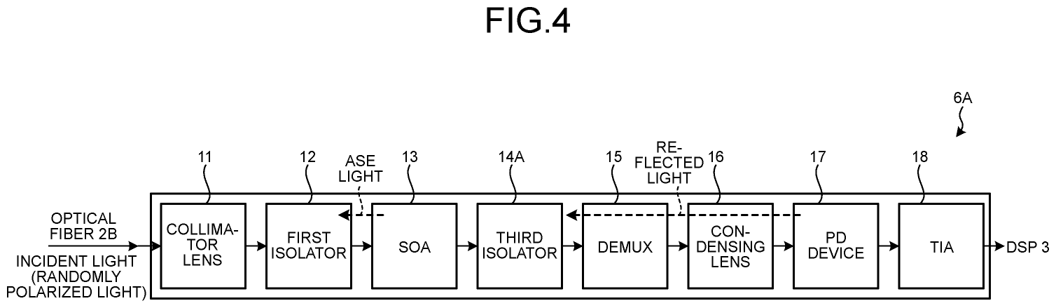

FIG. 4 is an explanatory diagram illustrating an example of a configuration of an optical receiver 6A of the second embodiment. Meanwhile, the same components as those of the optical receiver 6 of the first embodiment are denoted by the same reference symbols, and explanation of the same components and the same operation will be omitted. The optical receiver 6A illustrated in FIG. 4 is different from the optical receiver 6 illustrated in FIG. 2 in that a third isolator 14A is arranged instead of the second isolator 14.

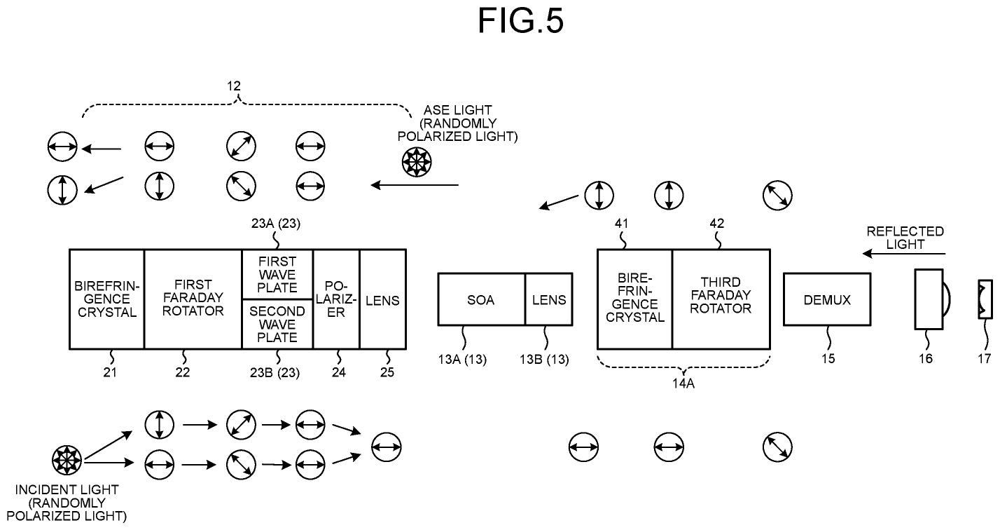

FIG. 5 is an explanatory diagram illustrating an example of polarization states of incident light of the first isolator 12, incident light of the third isolator 14A, ASE light of the first isolator 12, and reflected light of the third isolator 14A in the optical receiver 6A of the second embodiment. The third isolator 14A includes a birefringence crystal 41 and a third faraday rotator 42.

A polarization state of incident light that travels in the forward direction from the SOA 13 to the DEMUX 15 in the third isolator 14A will be described below. The birefringence crystal 41 in the third isolator 14A, when the incident light of the linearly-polarized light of the horizontally polarized component that has been optically amplified is input from the SOA 13 in the forward direction, transmits only the incident light of the horizontally polarized component. The third faraday rotator 42 rotates the horizontally polarized component of the linearly-polarized light, which has transmitted through the birefringence crystal 41, by 45 degrees in the clockwise direction. Further, the third faraday rotator 42 inputs the incident light of the linearly-polarized light of the horizontally polarized component, which has been rotated by 45 degrees in the clockwise direction, to the DEMUX 15.

A polarization state of reflected light that travels in the reverse direction from the PD device 17 to the SOA 13 in the third isolator 14A will be described below. The third faraday rotator 42 in the third isolator 14A receives input of reflected light of the incident light of the linearly-polarized light of the horizontally polarized component, which has been rotated by 45 degrees in the clockwise direction, in the reverse direction from the light receiving surface of the PD device 17 via the DEMUX 15. The third faraday rotator 42 has a non-reciprocal property so as to perform rotation in the same direction both in the forward direction and the reverse direction. The third faraday rotator 42, when the reflected light of the horizontally polarized component that has been rotated by 45 degrees in the clockwise direction is input from the reverse direction, rotates the reflected light of the horizontally polarized component, which has been rotated by 45 degrees in the clockwise direction, by 45 degrees in the clockwise direction to obtain reflected light of a vertically polarized component of linearly-polarized light.

The birefringence crystal 41 transmits only the horizontally polarized component even in the reverse direction, so that the reflected light of the vertically polarized component coming from the third faraday rotator 42 is refracted and deviates from the optical path of the rear-stage lens 13B in the SOA 13. As a result, in the third isolator 14A, the third faraday rotator 42 rotates the reflected light of the linearly-polarized light with the polarization direction orthogonal to the incident light, and the birefringence crystal 41 refracts the reflected light, so that the light deviates from an optical path of the rear-stage lens 13B in the SOA 13. Therefore, it is possible to block incidence of the reflected light to the optical amplification area in the SOA 13.

The third isolator 14A in the optical receiver 6A of the second embodiment includes the birefringence crystal 41 that, when the incident light of the horizontally polarized component that has been optically amplified by the SOA 13 is input, refracts and transmits the horizontally polarized component from the incident light of the horizontally polarized component. Furthermore, the third isolator 14A includes the third faraday rotator 42 that rotates the horizontally polarized component, which has transmitted through the birefringence crystal 41, by 45 degrees in the clockwise direction, and outputs the incident light of the horizontally polarized component that has been rotated by 45 degrees. The third faraday rotator 42, when the reflected light of the incident light of the horizontally polarized component that has been rotated by 45 degrees is input from the reverse direction, rotates the reflected light by 45 degrees in the clockwise direction, so as to obtain reflected light of a vertically polarized component from the reflected light of the horizontally polarized component that has been rotated by 45 degrees. The birefringence crystal 41 refracts the reflected light of the vertically polarized component coming from the third faraday rotator 42 such that the light deviates from the optical path to the SOA 13, and blocks incidence of the light to the SOA 13. Furthermore, it is possible to reduce the size of the entire optical receiver 6A by simplifying the internal configuration of the third isolator 14A.

Moreover, the first wave plate 23A may rotate the vertically polarized component, which has been rotated by 45 degrees in the clockwise direction by the first faraday rotator 22, by 45 degrees in the counterclockwise direction to obtain a vertically polarized component. Furthermore, the second wave plate 23B may rotate the horizontally polarized component, which has been rotated by 45 degrees in the clockwise direction by the first faraday rotator 22, by 45 degrees in the clockwise direction to obtain a vertically polarized component. In this case, the polarizer 24 and the birefringence crystal 41 in the third isolator 14A transmit only the incident light of the linearly-polarized light of the vertically polarized component, and the third faraday rotator 42 inputs the reflected light of the horizontally polarized component to the birefringence crystal 41. Moreover, it may be possible to block incidence of the reflected light of the horizontally polarized component to the SOA 13, and an appropriate change is applicable.

Meanwhile, the example has been described in which the second isolator 14 of the optical receiver 6 of the first embodiment includes the PBS 31 and the second faraday rotator 32, but embodiments are not limited to this example, and a different embodiment will be described below as a third embodiment.

### (c) Third Embodiment

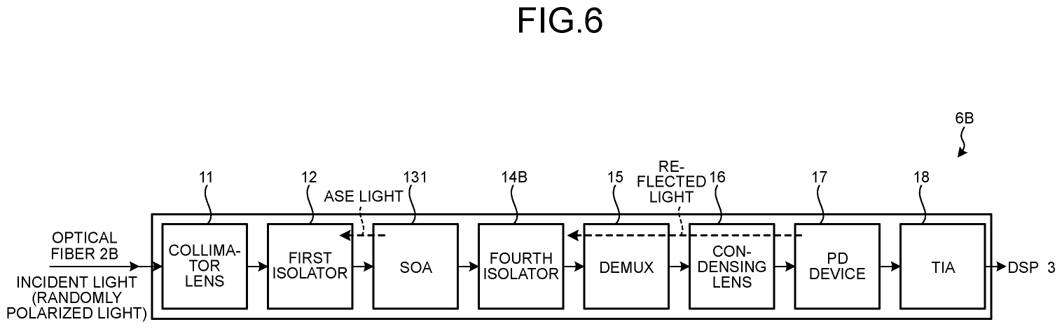

FIG. 6 is an explanatory diagram illustrating an example of a configuration of an optical receiver 6B of the third embodiment. Meanwhile, the same components as those of the optical receiver 6 of the first embodiment are denoted by the same reference symbols, and explanation of the same configuration and the same operation will be omitted. The optical receiver 6B illustrated in FIG. 6 is different from the optical receiver 6 illustrated in FIG. 2 in that a fourth isolator 14B is arranged instead of the second isolator 14, and an SOA 131 that is highly dependent on the polarization direction is arranged instead of the SOA 13. Furthermore, the SOA 131 is an optical amplifier that is highly dependent on the polarization direction such that an amplification factor of a horizontally polarized component is increased but an amplification factor of a polarized component different from the horizontally polarized component is reduced, for example. The SOA 131 includes an SOA main body 131A and a rear-stage lens 131B. The SOA main body 131A optically amplifies incident light of a horizontally polarized component of linearly-polarized light that is collected by the lens 25 in the first isolator 12. The rear-stage lens 131B is a lens that converts the incident light that is optically amplified by the SOA main body 131A into parallel incident light.

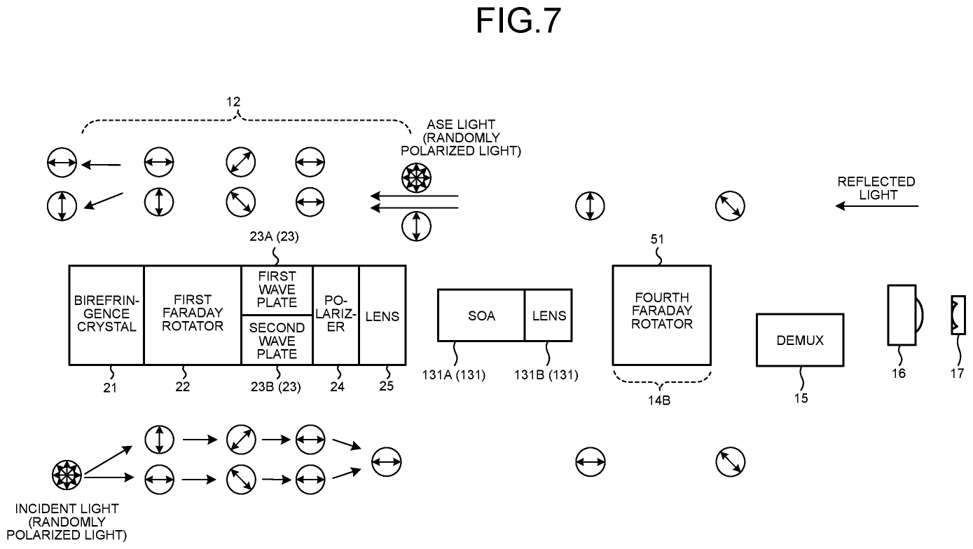

FIG. 7 is an explanatory diagram illustrating an example of polarization states of incident light of the first isolator 12, incident light of the fourth isolator 14B, ASE light of the first isolator 12, and reflected light of the fourth isolator 14B in the optical receiver 6B of the third embodiment. The fourth isolator 14B illustrated in FIG. 7 includes a fourth faraday rotator 51.

A polarization state of incident light that travels in the forward direction from the SOA 131 to the DEMUX 15 in the fourth isolator 14B will be described below. The fourth faraday rotator 51 in the fourth isolator 14B, when the incident light of that has been amplified by the SOA 131 is input from the forward direction, rotates the incident light of the linearly-polarized light of the horizontally polarized component by 45 degrees in the clockwise direction. Further, the fourth faraday rotator 51 inputs the incident light of the linearly-polarized light of the horizontally polarized component, which has been rotated by 45 degrees in the clockwise direction, to the DEMUX 15.

A polarization state of reflected light that travels in the reverse direction from the PD device 17 to the SOA 131 in the fourth isolator 14B will be described below. The fourth faraday rotator 51 in the fourth isolator 14B receives input of reflected light of the incident light of the linearly-polarized light of the horizontally polarized component, which has been rotated by 45 degrees in the clockwise direction, in the reverse direction from the light receiving surface of the PD device 17 via the DEMUX 15. The fourth faraday rotator 51 has a non-reciprocal property so as to perform rotation in the same direction both in the forward direction and the reverse direction. The fourth faraday rotator 51, when the reflected light of the horizontally polarized component that has been rotated by 45 degrees in the clockwise direction is input from the reverse direction, rotates the reflected light of the horizontally polarized component, which has been rotated by 45 degrees in the clockwise direction, by 45 degrees in the clockwise direction to obtain reflected light of a vertically polarized component of linearly-polarized light. Furthermore, the fourth faraday rotator 51 inputs the reflected light of the linearly-polarized light of the vertically polarized component to the SOA 131 from the reverse direction.

However, the SOA 131 is an optical amplifier that is highly dependent on the polarization direction such that the amplification factor of the horizontally polarized component is increased, so that even if the reflected light of the vertically polarized component is input from the fourth faraday rotator 51, an amplification factor of the reflected light of the vertically polarized component remains low. As a result, it is possible to reduce an influence of the reflected light on the SOA 131.

Furthermore, the SOA 131 inputs the reflected light of the vertically polarized component from the fourth isolator 14B, but the reflected light of the vertically polarized component and the ASE light of the SOA 131 are input to the lens 25 in the first isolator 12. The lens 25 in the first isolator 12, when the randomly polarized ASE light and the reflected light of the vertically polarized component are input from the SOA 13 in the reverse direction, converts the randomly polarized ASE light and the reflected light of the vertically polarized component into parallel light. The polarizer 24, when the parallel ASE light and the parallel reflected light are input from the lens 25, transmits only the linearly-polarized light of the horizontally polarized component from the parallel ASE light and the parallel reflected light.

The first wave plate 23A in the polarization unit 23 rotates the ASE light and the reflected light of the horizontally polarized component of the light, which have been transmitted through the polarizer 24 and input to the first wave plate 23A, by 45 degrees in the counterclockwise direction. Furthermore, the second wave plate 23B in the polarization unit 23 rotates the ASE light and the reflected light of the horizontally polarized component of the light, which have been transmitted through the polarizer 24 and input to the second wave plate 23B, by 45 degrees in the clockwise direction. The first faraday rotator 22 rotates the horizontally polarized component, which comes from the first wave plate 23A after being rotated by 45 degrees in the counterclockwise direction, by 45 degrees in the clockwise direction to obtain ASE light and reflected light of linearly-polarized light of a vertically polarized component. Moreover, the first faraday rotator 22 rotates the horizontally polarized component, which comes from the second wave plate 23B after being rotated by 45 degrees in the clockwise direction, by 45 degrees in the clockwise direction to obtain ASE light and reflected light of linearly-polarized light of a horizontally polarized component.

Furthermore, the birefringence crystal 21, even when the ASE light and the reflected light of the horizontally polarized component and the vertically polarized component are input from the first faraday rotator 22 in the reverse direction, refracts the ASE light and the reflected light in directions in which the ASE light and the reflected light of the horizontally polarized component and the ASE light and the reflected light of the vertically polarized component do not optically coupled with each other. As a result, the first isolator 12 blocks, by the birefringence crystal 21, incidence of the ASE light and the reflected light from the reverse direction to the optical fiber via the collimator lens 11.

The optical receiver 6B of the third embodiment includes the SOA 131 with polarization dependence for reducing the optical amplification factor of a polarized component different from the horizontally polarized component as compared to the optical amplification factor of the horizontally polarized component. Furthermore, the fourth isolator 14B includes the fourth faraday rotator 51 that, when the incident light of the horizontally polarized component that has been optically amplified is input, rotates the incident light of the horizontally polarized component by 45 degrees in the clockwise direction, and outputs the incident light of the horizontally polarized component that has been rotated by 45 degrees. The fourth faraday rotator 51, when the reflected light of the incident light of the horizontally polarized component that has been rotated by 45 degrees is input, rotates the reflected light by 45 degrees in the clockwise direction. Moreover, the fourth faraday rotator 51 obtains the reflected light of the vertically polarized component from the reflected light of the horizontally polarized component that has been rotated by 45 degrees, and inputs the reflected light of the vertically polarized component to the SOA. As a result, because the SOA 131 is the optical amplifier that is highly dependent on the polarization direction, even if the reflected light of the vertically polarized component is input from the fourth faraday rotator 51, it is possible to reduce an influence of the reflected light on the SOA 131. Moreover, it is possible to reduce the size of the entire optical receiver 6B by simplifying the internal configuration of the fourth isolator 14B.

Furthermore, the first wave plate 23A may rotate the vertically polarized component, which has been rotated by 45 degrees in the clockwise direction by the first faraday rotator 22, by 45 degrees in the counterclockwise direction to obtain a vertically polarized component. Moreover, the second wave plate 23B may rotate the horizontally polarized component, which has been rotated by 45 degrees in the clockwise direction by the first faraday rotator 22, by 45 degrees in the clockwise direction to obtain a vertically polarized component. In this case, the SOA 131 is configured as an optical amplifier that is highly dependent on the polarization direction such that the amplification factor of the vertically polarized component is increased.

According to one embodiment of the optical device or the like disclosed in the present application, it is possible to reduce the size of the entire optical receiver by simplifying a configuration of a part of isolators.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
an optical amplifier that optically amplifies incident light;
a first isolator that is arranged on an input stage of the optical amplifier and inputs the incident light to the optical amplifier; and
a second isolator that is arranged on an output stage of the optical amplifier and receives input of incident light that has been optically amplified by the optical amplifier, wherein
the first isolator converts randomly-polarized incident light into first linearly-polarized incident light, transmits the first linearly-polarized incident light, and inputs the transmitted first linearly-polarized incident light to the optical amplifier, and
the second isolator, when reflected light of the first linearly-polarized incident light that has been optically amplified by the optical amplifier is input from a reverse direction, converts the reflected light of the first linearly-polarized incident light into reflected light of second linearly-polarized light that is orthogonal to the reflected light of the first linearly-polarized incident light.

2. The optical device according to claim 1, wherein
the first isolator includes a birefringence crystal, a faraday rotator, a first wave plate, a second wave plate, a polarizer, and a lens that are arranged in this order,
the birefringence crystal splitting parallel light that is converted from the randomly-polarized incident light into first linearly-polarized light and second linearly-polarized light that are orthogonal to each other,
the faraday rotator having a non-reciprocal property so as to rotate the first linearly-polarized light and the second linearly-polarized light that are split by the birefringence crystal by 45 degrees in a first polarization direction,
the first wave plate rotating the second linearly-polarized light that has been rotated by 45 degrees in the first polarization direction by the faraday rotator, by 45 degrees in the first polarization direction to obtain the first linearly-polarized light from the second linearly-polarized light that has been rotated by 45 degrees in the first polarization direction,
the second wave plate rotating the first linearly-polarized light that has been rotated by 45 degrees in the first polarization direction by the faraday rotator, by 45 degrees in a second polarization direction that is a reverse direction of the first polarization direction to obtain first linearly-polarized light for which the first polarization direction is set to zero degree,
the polarizer transmitting only the first linearly-polarized incident light among the first linearly-polarized light coming from the first wave plate and the first linearly-polarized light coming from the second wave plate,
the lens collecting the first linearly-polarized incident light that has transmitted through the polarizer and inputting the first linearly-polarized incident light to the optical amplifier, and
the first linearly-polarized incident light that travels in the forward direction from the birefringence crystal to the optical amplifier is input to the optical amplifier.

3. The optical device according to claim 2, wherein
the lens, when randomly polarized spontaneous emission light is input from the optical amplifier, converts the spontaneous emission light to parallel light,
the polarizer, when the parallel light of the spontaneous emission light is input from the lens, splits the parallel light of the spontaneous emission light to the first linearly-polarized light of an identical polarized component, and inputs the first linearly-polarized light of the split identical polarized component to the first wave plate and the second wave plate,
the first wave plate rotates one beam of the first linearly-polarized light that is split by the polarizer by 45 degrees in the second polarization direction,
the second wave plate rotates another beam of the first linearly-polarized light that is split by the polarizer by 45 degrees in the first polarization direction,
the faraday rotator rotates the first linearly-polarized light that comes from the first wave plate after being rotated by 45 degrees in the second polarization direction, by 45 degrees in the first polarization direction to obtain first linearly-polarized light that is totally rotated by zero degree, and rotates the first linearly-polarized light that comes from the second wave plate after being rotated by 45 degrees in the first polarization direction, by 45 degrees in the first polarization direction to obtain second linearly-polarized light that is first linearly-polarized light that is totally rotated by 90 degrees, and
the birefringence crystal refracts the first linearly-polarized light and the second linearly-polarized light coming from the faraday rotator such that the first linearly-polarized light and the second linearly-polarized light do not optically coupled with each other, and blocks emission of the spontaneous emission light in the reverse direction.

4. The optical device according to claim 3, wherein
the second isolator includes
a polarization beam splitter that, when the first linearly-polarized incident light that has been optically amplified by the optical amplifier is input, transmits the first linearly-polarized light from the first linearly-polarized incident light; and
a faraday rotator that has a non-reciprocal property to rotate the first linearly-polarized light that has transmitted through the polarization beam splitter by 45 degrees in the first polarization direction, and emits the first linearly-polarized incident light that has been rotated by 45 degrees,
the different faraday rotator, when reflected light of the incident light of the first linearly-polarized light that has been rotated by 45 degrees is input from a reverse direction, rotates the reflected light by 45 degrees in the first polarization direction to obtain reflected light of second linearly-polarized light from the reflected light of the first linearly-polarized light that has been rotated by 45 degrees in the first polarization direction, and
the polarization beam splitter blocks incidence of the reflected light of the second linearly-polarized light from the different faraday rotator to the optical amplifier.

5. The optical device according to claim 3, wherein
the second isolator includes
a different birefringence crystal that, when the first linearly-polarized incident light that has been optically amplified by the optical amplifier is input, refracts and transmits the first linearly-polarized light from the first linearly-polarized incident light; and
a different faraday rotator that has a non-reciprocal property to rotate the first linearly-polarized light that has transmitted through the different birefringence crystal by 45 degrees in the first polarization direction, and emits the first linearly-polarized incident light that has been rotated by 45 degrees,
the different faraday rotator, when reflected light of the incident light of the first linearly-polarized light that has been rotated by 45 degrees is input from a reverse direction, rotates the reflected light by 45 degrees in the first polarization direction to change the reflected light of the first linearly-polarized light that has been rotated by 45 degrees in the first polarization direction to reflected light of second linearly-polarized light, and
the different birefringence crystal refracts the reflected light of the second linearly-polarized light coming from the different faraday rotator to deviate from an optical path to the optical amplifier, and blocks incidence of light to the optical amplifier.

6. The optical device according to claim 3, wherein
the optical amplifier is an optical amplifier with polarization dependence so as to optically amplifies the first linearly-polarized incident light and reduce an optical amplification factor of a polarized component different from the first linearly-polarized light as compared to an optical amplification factor of the first linearly-polarized light,
the second isolator includes a different faraday rotator that has non-reciprocal property to, upon incidence of the first linearly-polarized incident light that has been optically amplified by the optical amplifier, rotates the first linearly-polarized incident light by 45 degrees in the first polarization direction, and emits the first linearly-polarized incident light that has been rotated by 45 degrees, and
the different faraday rotator, when reflected light of the first linearly-polarized incident light that has been rotated by 45 degrees is input from a reverse direction, rotates the reflected light by 45 degrees in the first polarization direction to change the reflected light of the first linearly-polarized light that has been rotated by 45 degrees to reflected light of second linearly-polarized light, and inputs the reflected light of the second linearly-polarized light to the optical amplifier.

7. An optical reception apparatus comprising:
a first isolator that is arranged on an input stage of an optical amplifier that optically amplifies incident light, and inputs the incident light to the optical amplifier;
a second isolator that is arranged on an output stage of the optical amplifier and receives input of incident light that has been optically amplified by the optical amplifier; and
a light receiving device that receives the optically amplified incident light from the second isolator, wherein
the first isolator inputs first linearly-polarized incident light that has been converted from randomly-polarized incident light and that has been transmitted to the optical amplifier; and
the second isolator, when reflected light of the first linearly-polarized incident light that has been optically amplified by the optical amplifier is input from a the reverse direction, converts the reflected light of the first linearly-polarized incident light to reflected light of second linearly-polarized light that is orthogonal to the reflected light of the first linearly-polarized incident light.
